(19) United States
(12) Patent Application Publication
(10) Pub. No.: US 2017/0061946 A1
(43) Pub. Date: Mar. 2, 2017

(54) Micro-fabricated Hearing Protection Device and Methods of Producing Thereof

(71) Applicant: Anru Cheng, Lexington, MA (US)

(72) Inventor: Anru Cheng, Lexington, MA (US)

(21) Appl. No.: 15/247,390

(22) Filed: Aug. 25, 2016

Related U.S. Application Data
(60) Provisional application No. 62/210,364, filed on Aug. 26, 2015.

(51) Int. Cl. G10K 11/00; G10K 11/162

(52) U.S. Cl. CPC G10K 11/002; G10K 11/162

(57) ABSTRACT

Micro-fabricated hearing protection devices are described. One such device includes 1) a movable, yet non-expandable diaphragm, and 2) a stationary proliferated backplane which is separated by an air gap, whereby sound pressure causes the movable diaphragm to vibrate and when the sound exceeds threshold, the movable diaphragm deflects and presses against the proliferated backplane restricting further movement thus attenuates incoming sound. Methods of producing the micro-fabricated hearing protection device are also described.

### CROSS-REFERENCE TO RELATED APPLICATIONS

This application claims priority to U.S. provisional application No. 62/210,364, filed on Aug. 26, 2015

### STATEMENT REGARDING FEDERALLY SPONSORED RESEARCH OR DEVELOPMENT

N/A

### BACKGROUND

Field of the Technology

The present invention relates to a passive micro-fabricated hearing protection device and in particular may be used in conjunction with macro-sized acoustic devices such as ear plugs, ear phones, headphones, helmets, and microphone housings.

Background

Noise Induced Hearing Loss (NIHL) is one of the major avoidable occupational hazards, particularly in developing countries, where occupational and environmental noise remains the major risk factor for hearing impairment. Even in developed countries hearing impairment continues to remain a common health disorder, leaving a largely untapped market to be exploited. More than 120 million workers across the globe are exposed to dangerously high noise levels (over 85 dB). The Occupational Safety and Health Administration estimates that around 30 million people in the U.S. are exposed to dangerously loud noise levels in their day-to-day life, with those in metalworking, manufacturing, coalmines, dockyard (fishermen) and construction, and hospitality industries comprising the most highly risk-prone groups.

There is also a pressing need to develop a passive hearing protection device that helps military personnel reducing the risk of developing tinnitus and noise-induced hearing loss by protecting against transient harmful impact noise from explosions or firearms while allowing for hearing mission critical communication with minimum attenuation and distortion. Tinnitus, often referred to as “ringing in the ears,” and noise-induced hearing loss can be caused by a one-time exposure to hazardous impulse noise, or by repeated exposure to excessive noise over an extended period of time. Using the proper ear protection can prevent irreparable damage to the eardrums.

Conventional ear plugs and over-the-ear muffs attenuate both harmful impact noise as well as the sound of normal speech. To date, non-linear membrane technology is by far, the most innovative passive approach to hearing protection. Such technology aims at providing non-linear noise attenuation (U.S. Pat. No. 8,249,285B2) such that the attenuation is higher for high level sounds than for lower level sounds. Such non-linear noise attenuating device comprises housing with a hollow passageway for passing external sound through a flexible membrane. Typically the flexible membrane is made of polyethylene or Teflon foil. The device has three regimes of operation: normal sound, threshold sound, and maximum sound. Under normal sound environment, sound pressure causes the flexible membrane to expand allowing user to hear ambient sound. On the other hand, when the sound level reaches a threshold value (125 dB), the flexible membrane hits a perforated over-stop restricting the membrane to expand. When the sound level exceeds the peak value (125-171 dB), the membrane expands further through the perforation thus attenuating non-linearly.

There are several shortcomings relating to the existing non-linear noise attenuating device. First, during the normal sound regime, the existing membrane attenuates greatly due to the thick membrane and distorts the signal tremendously due to the uneven membrane stress. Such attenuation distorts the signal making users difficult to hear and understand speech properly. Second, in the maximum sound regime, the existing membrane still deflects due to high membrane elasticity and thus attenuates ineffectively. Finally, since there is no quality control on membrane manufacturing (such as internal stress, and thickness), attenuation varies from device to device.

Thus, there exists a need to new approach for non-linear attenuation device that provides a low, uniform attenuation at all frequencies below a threshold value (e.g. 125 dB), yet provides a higher and increasing level of attenuation for sound level above that threshold.

### BRIEF SUMMARY

The below summary is merely representative and non-limiting. The above problems are overcome, and other advantages may be realized, by the use of the embodiments.

This invention discloses a micro-fabricated hearing protection device that will allow significant enhancement in the ability to optimize the detection of low level ambient sound without distortion while shunting off high level impact noise. Such hearing protection device offers unique acoustic engineering capabilities allowing users to hear mission critical communication, while helping reduce the risk of developing tinnitus and noise-induced hearing loss. The significant of this invention is that it is a low-cost passive hearing protection that protects users against transient impact noise while allowing for ambient sound without minimum attenuation and distortion. The micro-fabricated hearing protection device offers non-distorted acoustic performance on normal sound, but rejects harmful sound when the diaphragm of the device is restricted by an over-stop for further movement. It is believed that this hearing protection device would achieve the specifications stated in the program such that it attenuates at least 30dB of impact noise at 125 dB, 140 dB, 160 dB and 171 dB; and a Noise Reduction Rate (NRR) of 12 or less between 30 to 60 dB.

Various embodiments provides an acoustic attenuating device comprising an ear mold comprising a hollow passageway, and a micro-fabricated hearing protection device interposed across the hollow passageway, wherein said micro-fabricated hearing protection device comprising a movable, yet non-expandable diaphragm unlike the diaphragm described in U.S. Pat. No. 8,249,285B2, and a stationary proliferated backplane which is separated by an air gap, whereby sound pressure causes the movable diaphragm to vibrate and when the sound exceeds threshold, the movable diaphragm deflects and presses against the proliferated backplane restricting further movement thus attenuates incoming sound. The sound pressure threshold according to claim 1 is approximately 140 dB. Further, the sound pressure threshold is approximately 125 dB. Even further the sound pressure threshold is approximately 85 dB. The proliferated backplane has at least one hole. The proliferated backplane is but not limited to un-doped polysilicon, doped polysilicon, silicon, doped silicon, silicon nitride, silicon oxide, metal, polymer, or any combinations. The thickness of the micro-fabricated diaphragm is less than 10 micrometers. The thickness of the micro-fabricated diaphragm is less than 2 micrometers. The micro-fabricated diaphragm is but not limited to un-doped polysilicon, doped polysilicon, silicon, doped silicon, silicon nitride, silicon oxide, metal, polymer, or any combinations. The air gap is less than 10 micrometers. Further, the air gap according to claim 1 is less than 2 micrometers. Further to claim 1, the surface of the said diaphragm and the said proliferated backplane that pressed on each other is coated with an anti-stiction layer. The anti-stiction layer according to claim 11 could be a self-assembled monolayer. The anti-stiction layer according to claim 11 could be but not limited to dichlorodimethylsilane (DDMS) or 1H,1H,2H,2H-Perfluorodecyltrichlorosilane (FDTS).

A method of attenuating incoming sound comprising the steps: a) providing an ear mold comprising a hollow passageway, and b) providing a micro-fabricated hearing protection device interposed across the hollow passageway, wherein said micro-fabricated hearing protection device comprising a movable, yet non-expandable diaphragm, and a stationary proliferated backplane which is separated by an air-gap, whereby sound pressure causes the movable diaphragm to vibrate and when the sound exceeds threshold, the movable diaphragm deflects and presses against the proliferated backplane restricting further movement thus attenuates incoming sound. The sound pressure threshold is approximately 140 dB. The sound pressure threshold is approximately 125 dB. The sound pressure threshold is approximately 85 dB. The proliferated backplane has at least one hole. The proliferated backplane is but not limited to un-doped polysilicon, doped polysilicon, silicon, doped silicon, silicon nitride, silicon oxide, metal, polymer, or any combinations. The thickness of the micro-fabricated diaphragm is less than 10 micrometers. The thickness of the micro-fabricated diaphragm is less than 2 micrometers. Further to claim 1, the surface of the said diaphragm and the said proliferated backplane that pressed on each other is coated with an anti-stiction layer. The anti-stiction layer could be a self-assembled monolayer. The anti-stiction layer could be but not limited to dichlorodimethylsilane (DDMS) or 1H,1H, 2H,2H-Perfluorodecyltrichlorosilane (FDTS).

### BRIEF DESCRIPTION OF THE SEVERAL VIEWS OF THE DRAWINGS

Various embodiments are illustrated by way of example, and not by way of limitation, in the Figures of the accompanying drawings and in which like reference numerals refer to similar elements and in which:

FIG. 1 shows the schematics of an embodiment of a macro-sized acoustic attenuating device

FIG. 2 shows the cross-section of an embodiment of a macro-sized acoustic attenuating device

FIG. 3 are simplified pictorial illustrations and a cross-sectional view (top) and top (bottom) view of the micro-fabricated hearing protection device.

FIG. 4 shows the operation of the micro-fabricated hearing protection device.

FIG. 5 illustrate a detailed diagrammatic cross-sectional process flow of a micro-fabricated hearing protection device.

### DETAILED DESCRIPTION

Various embodiments are described in detail with reference to a few examples thereof as illustrated in the accompanying drawing. In the following description, numerous specific details are set forth in order to provide a thorough understanding of this disclosure. It will be apparent, however, to one skilled in the art, that additional embodiments may be practiced without some or all of these specific details. Additionally, some details may be replaced with other well-known equivalents. In other instances, well-known process steps have not been described in detail in order to not unnecessarily obscure the present disclosure.

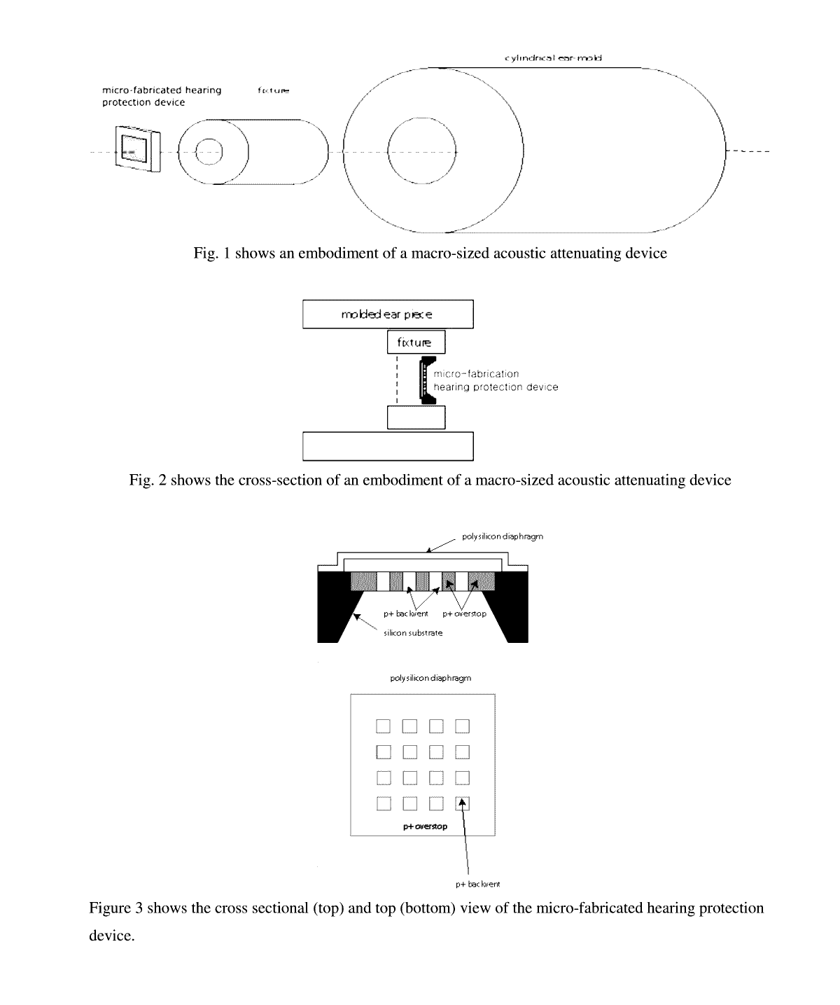

FIG. 1 shows the schematics of a macro-sized acoustic attenuating device featuring an ear-mold embedding a fixture with a hollow passageway for passing external sound through a micro-fabricated hearing protection device whereby the silicon chip is sealed to the fixture. The assembly of such embodiment could be rather simple. The micro-fabricated hearing protection device is attached to the plastic cylindrically fixture with adhesives such as epoxy. The fixture is pushed into the cylindrical ear-mold where the ear-mold is pre-drilled with the hole that fits and secures the fixture. FIG. 2 shows the cross-section of such hearing protection device. The lightweight hearing protection device is a passive non-linear attenuation device and does not contain any electronic components.

The macro-sized acoustic attenuating device includes, but not limited to, ear plug, ear phone, helmet, and microphone housings. Design of the macro-sized acoustic attenuating device is not limited by the size, shape or structure shown in FIG. 1. Embodiment of a macro-sized ear plug can be in form of cylindrical foam or ear plug having triple-flange eartip to keep the device in place. These ear-plugs would be low-cost high-attenuation plastic ear plugs that are easy to insert and are in compliance with Foreign Objects and Debris (FOD) requirements in proximity with military aircraft and flight lines. Such rubber ear plug should be robust and compatible with long term use.

Micro-Fabricated Hearing Protection Device

A major component of the invention is the micro-fabricated hearing protection device which offers non-distorted acoustic performance on normal sound, but rejects harmful sound when its over-stop restrict further movement of the diaphragm. It is believed that this hearing protection device would attenuates at least 30 dB of impact noise at 125 dB, 140 dB, 160 dB and 171 dB; and a Noise Reduction Rate (NRR) of 12 or less between 30 to 60 dB.

A major advantage of this hearing protection device is that it is micro-fabricated. The micro-fabricated hearing protection device is manufactured in a batch mode using Micro Electro Mechanical System (MEMS) technology similar to the integrated circuit fabrication process used in microelectronic industry. Batch processing of the micro-fabricated hearing protection device not only allows tight quality control, it also drives the manufacturing cost low as the volume of production increases.

FIG. 3 shows the cross sectional (top) and top (bottom) view of a micro-fabricated hearing protection device. In this embodiment, the device is constructed on top of silicon substrate etched to form a p+ over-stop perforation layer. Next, a diaphragm not limited to polysilicon is constructed as a suspended membrane on top of the over-stop layer separated by a micron-size air gap. Array of back-vent perforations are constructed on the over-stop layer to prevent pressure buildup when the diaphragm is pushed toward the over-stop.

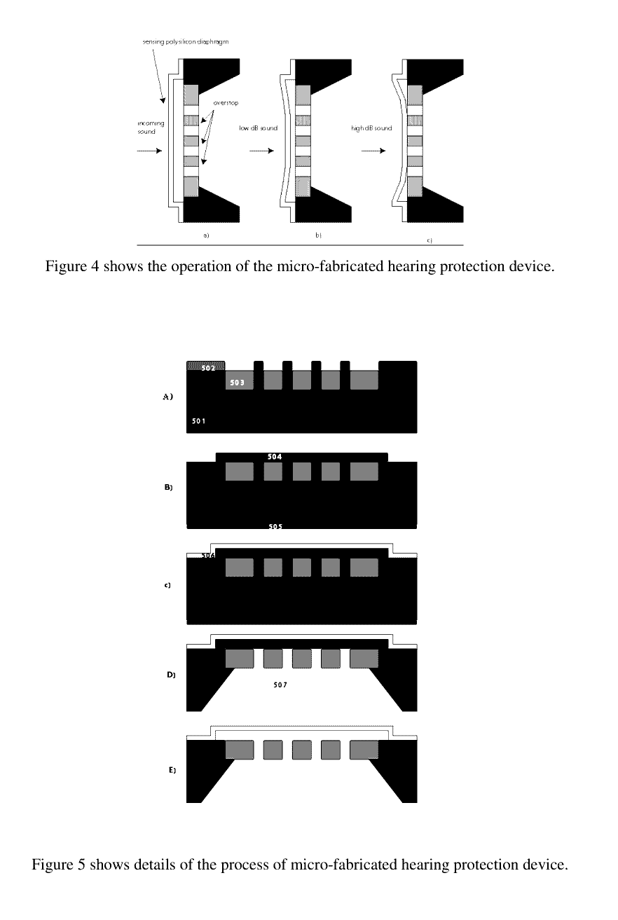

During the normal sound regime, incoming sound hits the sensing polysilicon diaphragm. The sensing diaphragm (see FIG. 4b) vibrates with amplitude depending on the strength of the incoming sound. The membrane attenuates slightly due to the thin (several micrometer thick) membrane with little distortion due to the uniform and tensile stress of the diaphragm. Such minimum signal attenuation and distortion making users easy to hear and understand speech properly. In threshold sound regime (see FIG. 4c), the micro-fabricated diaphragm contacts the backplane prohibiting its further movement. Any incoming signal greater than threshold sound would completely land on the backplane thus restricting any sound vibration. The threshold sound is determined by the diaphragm material, diaphragm thickness, gap distance (distance between diaphragm and backplane). In maximum sound regime, the diaphragm would not deflect through the backplane vent hole due to high mechanical strength of the diaphragm and thick backplane and with proper design of small backplane vent hole size Unlike polysilicon diaphragm, the polymer membrane to date will still deflect through small vent hole due to high membrane elasticity and thus attenuates ineffectively.

In order to achieve the thickness of the diaphragm and tight thickness tolerance, the diaphragm needs to be fabricated by thin film process. Selection of diaphragm material is also crucial since sensitivity increases tremendously with thin and low-tensile stress diaphragm. Under uniform tensile stress, the diaphragm would displace linearly with small perturbation of sound pressure. Thin film membrane materials such as doped polysilicon, un-doped polysilicon, p+ doped silicon, silicon nitride, polyimide and metal, and Teflon could be used. With high diaphragm sensitivity and minimal distortion, the micro-machined diaphragm shall maintain the ability of the user to detect, identify, and localize sound, with a goal of allowing for near-normal hearing in quiet environments.

Details of the process of micro-fabricated hearing protection device are shown in FIGS. 5A-5E. On silicon wafers (501), an oxide layer (502) is first grown. This oxide layer is patterned an etched in hydrofluoric acid serving as a mask for deep boron diffusion. A deep p+ boron diffusion (503) is next introduced from a solid source. The thick boron diffusion forms the backplane and thickness of the backplane can be ten of micrometers. The oxide mask is then stripped in hydrofluoric acid bath. A several micrometer thick sacrificial oxide is next deposited defining the air-gap spacing. This oxide is patterned and etched in hydrofluoric acid (see FIG. 5B). Next a thin layer of low pressure chemical vapor deposition low-stress polysilicon is deposited at elevated temperature (see FIG. 5C). The polysilicon could be doped. The polysilicon is next annealed at high temperature such as 1000 C to remove as much residual stress as possible. The polysilicon layer is then patterned and etched using reactive ion etching of SF6. An oxide is deposited on the front side to protect the polysilicon layer while oxide is also deposited and patterned on the backside of the substrate to form wet silicon etch mask. The substrate is then anisotropically etched in silicon etchant such as Ethylenediamine Pyrocatechol (EDP), potassium hydroxide or Tetramethylammonium hydroxide (TMAH) for 8 hours at 110 C (see FIG. 5D). After stripping the protective oxide layer on top and back of the substrate, the substrate is released in concentrated hydrofluoric acid for 1 hour (see FIG. 5E), such that the hydrofluoric acid removes the sacrificial oxide layer from the backside. The substrate is then coated with an anti-stiction layer. The anti-stiction layer could be a self-assembled monolayer. The anti-stiction layer could be dichlorodimethylsilane (DDMS) or 1H,1H, 2H,2H-Perfluorodecyltrichlorosilane (FDTS). Finally the substrate is diced.

What is claimed is:

1. An acoustic attenuating device comprising
a. an ear mold comprising a hollow passageway, and
b. at least one micro-fabricated hearing protection device interposed across the hollow passageway,
wherein said micro-fabricated hearing protection device comprising
i. a substrate,
ii. a movable yet non-expandable diaphragm, which is attached to the said substrate and
iii. a stationary proliferated backplane which is attached to the said substrate, whereby the said backplane is separated with the said diaphragm by an air gap, whereby sound pressure causes the movable diaphragm to vibrate and when the sound exceeds threshold, the movable diaphragm deflects and presses against the proliferated backplane restricting further movement thus attenuates incoming sound.

2. The diaphragm according to claim 1 has at least one dimple that faces the backplane.

3. The backplane according to claim 1 has at least one extrusion that faces the diaphragm.

4. The diaphragm according to claim 1 is bossed or corrugated.

5. The sound pressure threshold according to claim 1 is approximately 85 dB.

6. The thickness of the micro-fabricated diaphragm according to claim 1 is less than 10 micrometers.

7. The micro-fabricated diaphragm according to claim 1 is but not limited to un-doped polysilicon, doped polysilicon, silicon, doped silicon, silicon nitride, silicon oxide, metal, polymer, or any combinations.

8. The air gap according to claim 1 is less than 10 micrometers.

9. Further to claim 1, the surface of the said diaphragm and the said proliferated backplane that pressed on each other is coated with an anti-stiction layer which could be but not limited to dichlorodimethylsilane (DDMS) or 1H,1H,2H,2H-Perfluorodecyltrichlorosilane (FDTS).

10. A method of making an acoustic attenuating device comprising the steps:
a. providing an ear mold comprising a hollow passageway, and
b. at least one micro-fabricated hearing protection device interposed across the hollow passageway, wherein said micro-fabricated hearing protection device comprising
i. a substrate,
ii. a movable yet non-expandable diaphragm, which is attached to the said substrate and
iii. a stationary proliferated backplane which is attached to the said substrate, whereby the said backplane is separated with the said diaphragm by an air gap, whereby sound pressure causes the movable diaphragm to vibrate and when the sound exceeds threshold, the movable diaphragm deflects and presses against the proliferated backplane restricting further movement thus attenuates incoming sound.

11. The diaphragm according to claim 11 has at least one dimple that faces the backplane.

12. The backplane according to claim 11 has at least one extrusion that faces the diaphragm.

13. The diaphragm according to claim 11 is bossed or corrugated.

14. The sound pressure threshold according to claim 11 is approximately 85 dB.

15. The thickness of the micro-fabricated diaphragm according to claim 11 is less than 10 micrometers.

16. The micro-fabricated diaphragm according to claim 11 is but not limited to un-doped polysilicon, doped polysilicon, silicon, doped silicon, silicon nitride, silicon oxide, metal, polymer, or any combinations.

17. The air gap according to claim 11 is less than 10 micrometers.

18. Further to claim 11, the surface of the said diaphragm and the said proliferated backplane that pressed on each other is coated with an anti-stiction layer which could be but not limited to dichlorodimethylsilane (DDMS) or 1H,1H,2H,2H-Perfluorodecyltrichlorosilane (FDTS).

19. An acoustic attenuating device comprising
c. an ear mold comprising a hollow passageway, and
d. at least one micro-fabricated hearing protection device interposed across the hollow passageway,
wherein said micro-fabricated hearing protection device comprising
iv. a substrate,
v. a movable polymer diaphragm, which is attached to the said substrate and
vi. a stationary proliferated backplane which is attached to the said substrate, whereby the said backplane is separated with the said diaphragm by an air gap, whereby sound pressure causes the movable diaphragm to vibrate and when the sound exceeds threshold, the movable diaphragm deflects and presses against the proliferated backplane restricting further movement thus attenuates incoming sound.
